(19) United States
(12) Patent Application Publication
(10) Pub. No.: US 2004/0249537 A1
(43) Pub. Date: Dec. 9, 2004

(54) Machine tool and method for operating machine tool

(76) Inventors: Jurgen Legner, Friedrichshafen (DE); Wolfgang Rebholz, Friedrichshafen (DE); Hermann Beck, Eriskirch (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/493,807

(22) PCT Filed: Oct. 24, 2002
(86) PCT No.: PCT/EP02/11872

(30) Foreign Application Priority Data
Oct. 30, 2001 (DE) 101 53 458.2

(51) Int. Cl. G06G 7/00

(52) U.S. Cl. 701/50

(57) ABSTRACT

A proposed machine tool has one hydrostatic drive system, one lower chassis where one motor for driving the wheels and one upper chassis is provided which is pivotably disposed upon the lower chassis and comprises one pump for supplying the drive system with pressurized medium, wherein a rotating passage is situated between upper and lower chassis and, in the lower chassis, one or more electronic components are provided as lower-chassis electronic system and serve to control and/or regulate the components of the lower chassis.

According to the preamble of claim 1, the instant invention concerns a machine tool having a hydrostatic drive system, specially a mobile excavator, and a method for operating the machine tool.

Those machine tools are variously used, for example, as mobile excavators, cranes, etc. According to the prior art they have one hydrostatic drive system available and have one lower chassis and one upper chassis pivotally disposed upon the lower chassis; in the lower chassis is provided one engine for driving the wheels which is supplied with pressurized fluid by a pump located in the upper chassis, other high-pressure consumers may be provided.

According to the prior art in mobile excavators, no electric energy or electric components are provided, as a rule, in the lower chassis. The high-pressure and control-pressure hydraulics needed for the operation is conveyed from the upper to the lower chassis through a rotating passage. In the lower chassis are at least two high-pressure consumers (hydromotor for the drive system and leveling blade or support). In addition, the pressure supply for the mostly double-circuit hydraulic external force brake, the same as for the steering system, must be, likewise, conveyed from the upper to the lower chassis. Further needed are control signal lines for the creep gear engagement of the transmission and hydromotor, the same as the locking oscillating axle, which are also passed through the rotating passage. This results in a wasteful and expensive piping system for the above mentioned functions.

DE 199 56 402 A1 has disclosed a mobile excavator where the control valve needed to control the direction of motion and velocity of the vehicle is situated in the area of the lower chassis. Thereby the number of hydraulic connections for driving upon two lines is diminished, namely, a conveyor line and a tank line. But the number of other lines to be passed through the rotating passage still remains high.

Electric devices are often used in the lower chassis in folding machines or industrial equipments. In this equipment, the number of additional control and monitoring signals can no longer be hydraulically controlled so that, in this case, digital or electric control and monitoring signals are transmitted from the upper chassis to the lower chassis through the rotating passage. In the prior art, no electronic components are provided in the lower chassis.

For the drive system at present, there is normally used a high-pressure dependent continuously adjustable axial piston hydromotor with attached brake valve and secondarily sitting pressure-limiting valves. The engine remains at low absorption volume (qMin) until a standard high pressure is reached. When high pressure is constant, the engine is adjusted from low (qMin) to high (qMax) absorption volume whereby the torque is increased. The integrated, high-pressure dependent control is controlled by the supply high pressure only in the tugging operation. In the braking operation, the engine, in turn, remains at low absorption volume (qMin).

Conditioned by this control system, the hydraulic brake torque is limited to low values. A device with such control draft, as a rule, brakes with maximum retardation of about 10-12%. This means that situations can arise where the braking capacity is not enough to ensure a reliable operation. This can be the case, for example, while descending in the coasting operation when the drop is steeper than the braking capacity of the hydromotor whereby there is danger of overspeeding for the whole drive train.

This cannot be prevented by the driver releasing the accelerator pedal; the device hereby is not decelerated but accelerated. To this must be added that when the accelerator pedal is not actuated, no highly pressurized oil is conveyed by the pump to the hydromotor. The oil conveyed by the hydromotor at qMin cannot flow off through the brake valve to the tank but sprays off on the secondary valves to the low-pressure side. The very small volume of oil in the hydromotor is thereby very quickly heated and thus can destroy the hydromotor and in many cases even the attached transmission.

The problem on which this invention is based is to indicate a machine tool, in particular, a mobile excavator, which overcomes the disadvantages of the prior art. The number of lines between upper chassis and lower chassis is to be specially reduced and the security, the same as the driving comfort, increased. Besides it should be possible to carry out diagnoses of the components used which is not possible in the present state of the art.

It also should be possible to expand the functionality of the machine tool without great construction expenditure while lowering the costs of production.

To be also introduced is a method for operating the machine tool.

This problem is solved for a machine tool by the features of the characteristic part of claim 1. The method is object of claim 26. Other developments result from the sub-claims.

It is accordingly proposed to introduce one or more electronic components in the lower chassis serving to control and/or regulate the components of the lower chassis.

The inventive introduced lower-chassis electronic system is advantageously connected via a communication connection (for example, CAN or DC-bus) with the on-board electronic system in the upper chassis by means of a rotating passage. The voltage for the lower chassis is, likewise, supplied via the rotating passage.

By the proposed use of electronic components in the lower chassis many hydraulic connections between upper chassis and lower chassis are eliminated. The components in the lower chassis are electrically and/or hydraulically directly controlled and monitored. Thereby a diagnosis of the components is also made possible in the lower chassis, since any desired actuators and sensors can be diagnosed by the lower-chassis electronic system.

Besides, it is possible by the inventive construction to implement an enlarged offer of functions, as described in detail herebelow.

The invention is explained as follows with the aid of the drawing. In this drawing the figures present:

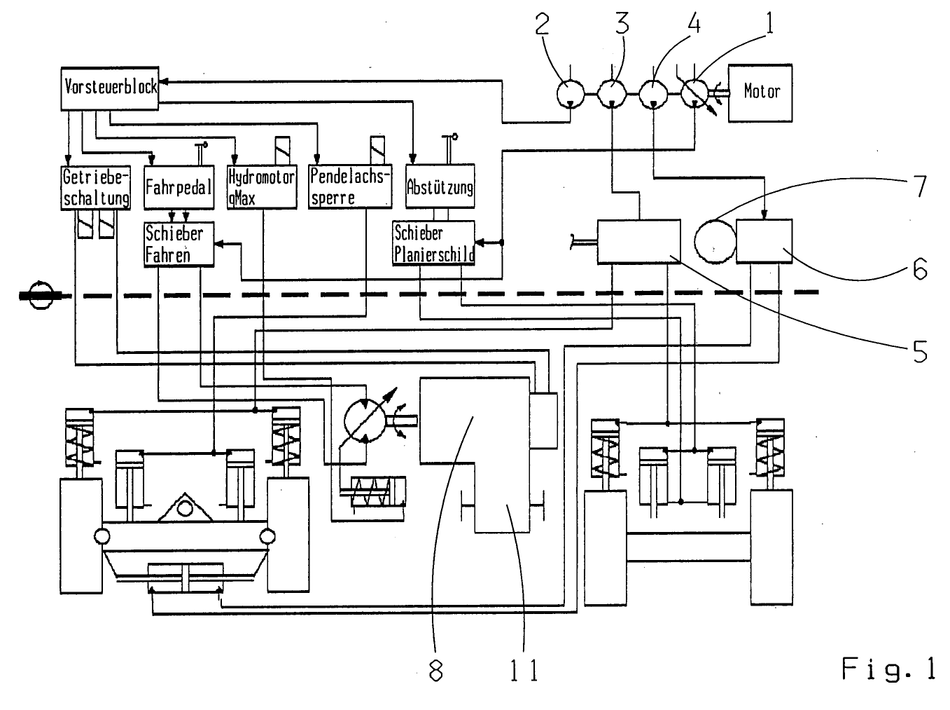

FIG. 1 is a block diagram of a mobile excavator according to the prior art;

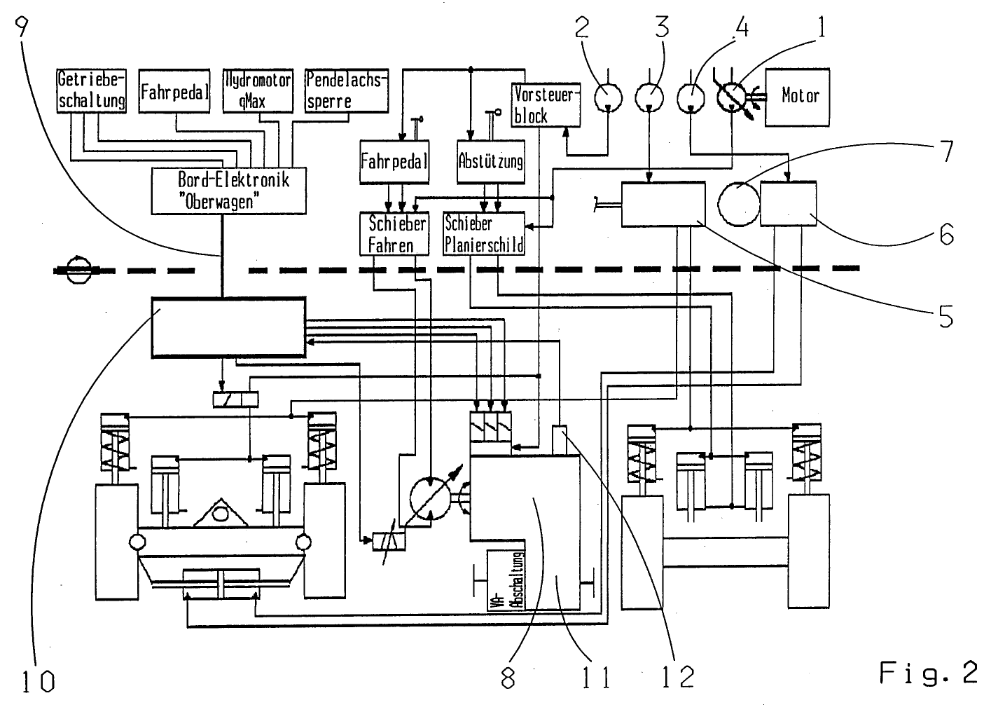

FIG. 2 is a block diagram of a mobile excavator according to a first embodiment of the invention; and

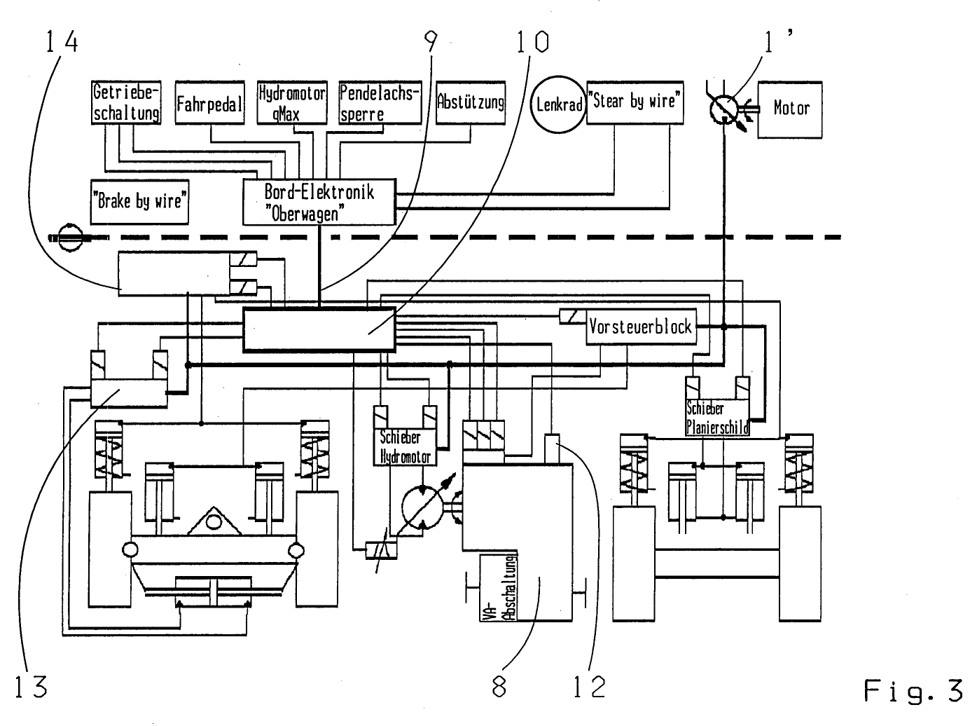

FIG. 3 is a block diagram of a mobile excavator according to one other embodiment of the invention.

In all Figures the separation between upper chassis and lower chassis is shown by the dotted line.

In the upper chassis of a machine tool of the prior art, according to FIG. 1, up to 4 pumps are attached to the internal combustion engine. Besides a main operating pump 1 there is one pilot pump 2, one braking pump 3 and one steering pump 4.

The main operating pump supplies all high-pressure consumers (cylinders, hydromotors) in an open hydraulic circuit. All high-pressure consumers in the lower chassis, such as hydromotor, leveling blade, support, must be supplied through the rotating passage. The pivoting function is at present partly operated with one other pump in the closed circuit.

The pilot pump 2 conveys the oil for the whole hydraulic pilot control. The pilot valves directly affect the different main control valves both in the upper chassis (beam, post, bucket, rotating mechanism, . . . ) and also in the lower chassis (engine, leveling blade, support, etc.). The hydraulic control functions in the lower chassis for the transmission shifting system, the hydromotor shifting (creep gear), locking oscillating axle, etc., are individually conveyed by the rotating passage.

In a brake compact block 5, with a memory loading unit, bubble memories are filled which, in case of failure of the pressure supply, allow a prescribed emergency operation. The brake compact block 5 is located in the upper chassis in a manner such that both brake circuits are hydraulically controlled by said block through the rotating passage.

A hydraulic steering unit 6 is placed directly on a steering wheel 7 in the cabin and is supplied with oil by the steering pump 4, two lines being guided by the hydraulic steering unit 6, via the rotating passage, to the double-acting steering cylinder.

In the prior art, in a transmission 8, a hydraulic downshift lock is provided which at high driving speed of the vehicle prevents a downshift and therewith overspeeding of the hydromotor.

In FIG. 2 is shown a block diagram of an inventive mobile excavator.

All—except one—control lines between upper chassis and lower chassis are accordingly eliminated. According to the invention, the control signals for transmission shifting, accelerator pedal, hydromotor and locking oscillating axle are conveyed by electric shift signals (analog or digital) to the upper-chassis electronic system; from there the control signals arrive via a communication connection 9 at a lower-chassis electronic system 10. The magnetic valves thus can be advantageously lodged in the lower chassis; they are controlled by means of the lower-chassis electronic system 10.

It is provided to situate a transmission control block 11 directly on the transmission 8 or on any other suitable place in the lower chassis. An additional function “front axle disconnection” is implemented with special advantage via a magnetic valve provided in the transmission control block which can be electrically controlled by the lower-chassis electronic system.

On the transmission input and/or output rotational speed is measured by a rotational speed sensor 12, said signal being processed by the lower-chassis electronic system 10 so that by means of this rotational speed information the downshift is electronically locked.

Within the scope of one variant of the invention, one automatic gear change is provided. To this end, the signals of the rotational speed transmitter and of the absorption volume adjustment, that is, the valve current to the hydromotor proportional valve, are evaluated by the lower-chassis electronic system 10.

The number of connections between upper chassis and lower chassis is clearly reduced in comparison with the prior art, additional functions in the lower chassis such as the front-axle disconnection described, for example, being possible without added connections between upper chassis and lower chassis.

By means of the inventive use of the lower-chassis electronic system, the functions in the lower chassis are logically linked. This results in a significant reduction of expenses and in an increase of security during the operation. In a mobile excavator with long boom and four-point-support, for example, the supports have to be extended and locked before it is possible to work with the boom.

Within the scope of another embodiment, instead of the hydromotor adjustable according to high pressure that is used at present, an electrically proportionally adjustable hydromotor is proposed to use with superimposed pressure regulation, the proportional valve of which can be controlled by the lower-chassis electronic system 10. The engine has one brake valve available wherein secondarily acting pressure-limiting valves are provided between engine and brake valve. When starting, this engine is at maximum absorption volume and consequently torque thus allowing better acceleration of the machine out of the stillstand. The engine can accordingly be adjusted, depending on the accelerator pedal position and on the input rotational speed of the transmission, to a lower absorption volume. To this end, an analog sensor is provided on the accelerator pedal. The accelerator pedal position can also be detected by means of a pressure sensor between “accelerator pedal” and “monitoring valve”.

The draft has the added advantage that in the braking position, the engine can targetedly be adjusted to higher absorption volume whereby overspeeding is prevented when driving uphill. While driving uphill, if the accelerator pedal is throttled back, result of the adjustment of the hydromotor, the brake torque steadily rises to higher absorption volume over a previously allowed time and the machine stops. Overspeeding can thus be almost eliminated. During uphill driving, the driver is thus compelled to actuate the accelerator pedal in order to be able to drive. The oil conveyed from the hydromotor so the tank is cooled to that overheating of the units in the lower chassis is to the greatest extent prevented.

A special advantageous variant of the invention, the object of FIG. 3, also provides, reducing to one connection, the hydraulic connections between upper and lower chassis. The number of line connections between upper and lower chassis thus becomes limited to three, namely, one hydraulic, one electric and one communication connections. The whole lower chassis thereby turns up as a closed system.

The number of oil pumps in the upper chassis is accordingly reduced from four to one main working pump 1′. All control commands go in the form of electric digitals or analog signals to the on-board electronic system in the upper chassis and from there, via the communication connection, to the lower-chassis electronic system 10 which relays the control signals to the actuators. Important state and diagnosis data are further diagnosed by the actuators and sensors from the lower chassis to the lower-chassis electronic unit 10 and reported to the on-board electronic system in the upper chassis via the communication connection 9 (“fault management”), it is possible after the evaluation to carry out emergency running and emergency operation programs.

To implement a load sensing regulation (high-pressure dependent required current regulation) of the main working pump 1′ situated in the upper chassis, the pressure of the consumer of highest load is signaled by the lower to the upper chassis. In addition, when reaching the capacity limit, the oil current in the upper chassis is uniformly reduced to all working consumers, the oil current to the consumers in the lower chassis being determined by the lower-chassis electronic system 10. This is specially important for the case that in the labor application, several consumers are needed at the same time (for example, hydromotor, leveling blade, etc.).

To detect the consumer of highest load, it is proposed within the scope of this invention to transmit, via pressure sensors in the load-pressure, conveying lines corresponding signals via the lower-chassis electronic system 10 to the upper-chassis electronic system, said signals being used to regulate the pump. This construction has the advantage that no additional connection between upper and lower chassis is needed.

One other variant for detecting the consumer of highest load provides the use of crossed recoil valves which convey the load pressure of the consumer of highest load via a hydraulic signal line to the upper chassis. Unlike in the first variant an additional hydraulic connection between upper and lower chassis is needed for this.

The hydraulic power for braking, steering, hydromotor and leveling blade form the central pressurized-oil supply of the lower chassis. The control oil preferably branches off through a control oil unit of the high-pressure supply of the lower chassis by a pressure reduction. All the consumers in the lower chassis are thus controlled by the electronic system 10 of the lower chassis.

Of particular advantage is the implementation by X-by wire systems, that is, by electronic systems which work entirely without mechanical reversion range for steering and braking (steer-by-wire, brake-by-wire) in order to increase the active security.

To this end, according to the invention, in the lower chassis are lodged, one proportional electrohydraulic steer-by-wire unit 13 and one brake-by-wire unit 14, the corresponding electronic control being integrated in the lower-chassis electronic system 10 or lodged in separate components.

The steer-by-wire components operate as follows: the steering wheel movements are converted to electric signals in the steer-by-wire unit in the upper chassis and conveyed to the upper-chassis electronic system. From there this information arrives via the communication 9 at the lower-chassis electronic system 10. The latter, in turn, then electrically controls the hydraulic steer-by-wire unit 13. In the steer-by-wire unit, the electronic signals are converted to hydraulic and relayed to the steering cylinder.

Hydraulic memories are provided for an emergency operation in the steer-by-wire unit 13 in the lower chassis. The steer-by-wire unit 13 can be attached both directly to the axle or to an adequate place in the lower chassis.

An advantageous development of the invention provides in an electromotor in the steer-by-wire unit in the upper chassis simulating steering forces upon the steering wheel in order to improve the driving feeling.

By means of such a steering device it should be possible to tilt it out of the driver's field of vision when driving in the construction site and operate the steering system via additional joysticks. When working, this should substantially improve visibility and contribute to increasing the security. In this connection, it is proposed to implement a restoring behavior when the steering wheel is released while cornering. An added advantage of the steer-by-wire system consists in the interference hydraulic noises from the driver cabin are dispelled.

To implement the brake-by-wire system, sensors are provided which detect the accelerator pedal motions and convert them to electric signals which are relayed to the upper-chassis electronic system. This information subsequently arrives via the communication connection at the lower-chassis electronic system which electrically controls the hydraulic brake-by-wire unit 14, the electric signals being converted in the brake-by-wire unit into hydraulic signals and relayed to the brake cylinders.

In the brake-by-wire unit 14 in the lower chassis hydraulic memories are, in addition, provided for the emergency operation. Within the scope of an advantageous development wheel rotational speed sensors are provided to make the implementation of functions such as ABS, ASR, etc., possible.

Reference Numberals

1,1′ main working pump

2 pilot pump

3 brake pump

4 steering pump

5 brake compact block

6 steering unit

7 steering wheel

8 transmission

9 communication connection

10 lower-chassis electronic system

11 transmission control block

12 rotational speed sensor

13 steer-by-wire unit

14 brake-by-wire unit

1-33. (CANCELED)

34. A machine tool with one hydrostatic drive system, specially mobile excavators, having one lower chassis in which is provided one engine for driving wheels and one upper chassis which is pivotally situated upon the lower chassis and comprising:
a pump for supply of the hydrostatic drive system with pressurized fluid,
a rotating passage being located between the upper and lower chassis, wherein in the lower chassis one or more electronic components are provided as a lower-chassis electronic system (10) and serve to one or more of control and regulate the one or more electrical components of the lower chassis.

35. The machine tool according to claim 34, wherein the lower-chassis electronic system (10) is connected via a communication connection (9) with an electronic system in the upper chassis, a voltage for the lower-chassis electronic system (10) being supplied via a rotating passage.

36. The machine tool according to claim 34, wherein one control line is provided between the upper and the lower chassis.

37. The machine tool according to claim 34, wherein the one or more electronic components, specially sensors and actuators, in the lower chassis can be one or more of electrically and hydraulically controlled and diagnosed by the lower-chassis electronic system (10).

38. The machine tool according to claim 34, wherein a transmission control block (11) is situated directly on a transmission (8) in the lower chassis.

39. The machine tool according to claim 38, wherein a function “front axle disconnection” is provided via a magnetic valve which is provided in the transmission control block (11) and can be electrically controlled by the lower-chassis electronic system (10).

40. The machine tool according to claim 34, wherein a downshift lock is provided which can be electronically controlled by the lower-chassis electronic system (10), one or mor of input and output rotational speeds are measurable by a rotational speed sensor (12) and evaluatable by the lower-chassis electronic system (10).

41. The machine tool according to claim 34, wherein an automatic gear shift is provided which can be controlled by the lower-chassis electronic system (10) with aid of signals of a rotational speed transmitter and of the absorption volume adjustment.

42. The machine tool according to claim 34, wherein functions in the lower chassis are logically linked via the lower-chassis electronic system (10).

43. The machine tool according to claim 34, wherein an electrically proportionally adjustable hydromotor with superimposed pressure regulation is provided, a proportional valve of which can be controlled by the lower-chassis electronic system (10), the engine having available one brake valve and secondarily acting pressure-limiting valves being provided between the engine and the brake valve.

44. The machine tool according to claim 43, wherein adjustment of the engine to a lower absorption volume depends on an accelerator pedal position and the input and the output rotational speed of the transmission can be controlled.

45. The machine tool according to claim 44, wherein an analog sensor is provided on one of the accelerator pedal or drive by a control pressure sensor between accelerator pedal and monitoring valve.

46. The machine tool according to claim 34, wherein hydraulic connections between the upper and the lower chassis are reduced to a single connection whereby a number of line connections between the upper and the lower chassis is limited to three, namely, one hydraulic, one electric and one communication connection (9).

47. The machine tool according to claim 46, wherein only one main working pump (1′) is situated in the upper chassis.

48. The machine tool according to claim 47, wherein the main working pump (1′) has available one high-pressure dependent required current regulation.

49. The machine tool according to claim 48, wherein in one of a load-pressure conveyor line pressure sensors are provided signals of which can be transmitted via the lower-chassis electronic system (10) to the upper-chassis electronic system for a purpose of regulating the main pump.

50. The machine tool according to claim 34, wherein one of steer-by-wire or brake-by-wire systems are provided for steering and braking.

51. The machine tool according to claim 50, wherein one proportional-electrohydraulic steer-by-wire unit (13) and one brake-by-wire unit (14) are situated in the lower chassis.

52. The machine tool according to claim 51, wherein electronic control of the steer-by-wire unit (13) and of the brake-by-wire unit (14) is one of integrated in the lower-chassis electronic system (10) or lodged in separate components.

53. The machine tool according to claim 50, wherein by means of the steer-by-wire unit (13) in the upper chassis, steering forces on a steering wheel (7) can be simulated by a provided electromotor.

54. The machine tool according to claim 34, wherein steering can be optionally operated by means of joysticks.

55. The machine tool according to claim 50, wherein sensors are provided which detect movements of the accelerator pedal, converting the movements to electric signals which can be relayed to the lower-chassis electronic system (10) for control of the brake-by-wire unit (14).

56. The machine tool according to claim 50, wherein hydraulic memories are provided in the brake-by-wire unit (14) in the lower chassis for an emergency operation.

57. The machine tool according to claim 34, wherein wheel rotational speed sensors are provided to implement one of ABS or ASR systems.

58. The machine tool according to claim 34, wherein hydraulic power for one of more of braking, steering, hydromotor and other consumers, branches off from a central pressurized-oil supply of the lower chassis, all consumers in the lower chassis being controlled by the lower-chassis electronic system (10).

59. A method for operating a machine tool with a hydrostatic drive system, specially a mobile excavator, having one lower chassis, where one engine is provided for driving wheels, and one upper chassis pivotally situated upon the lower chassis, comprising:
a pump for supply of pressurized medium to the drive system, there being located between upper and lower chassis a rotating passage,
wherein in the lower chassis one or more electronic components are inserted as the lower-chassis electronic system (10), which serve to control and regulate the components of the lower chassis.

60. The method according to claim 59, wherein sensors and actuators in the lower chassis are electrically and hydraulically directly controlled and diagnosed by the lower-chassis electronic system (10).

61. The method according to claim 59, wherein functions in the lower chassis are logically linked via the lower-chassis electronic system (10).

62. The method according to claim 59, wherein hydraulic power for braking, steering, hydromotor and other consumers branches off from a central pressurized-oil supply of the lower chassis, all consumers in the lower chassis being controlled by the lower-chassis electronic system (10).

63. The method according to claim 59, wherein a main working pump (1, 1′) has available one high-pressure dependent required current regulation, pressure of a consumer of highest load being informed by the lower chassis to the upper chassis and upon reaching a capacity limit, an oil current to the consumers is uniformly reduced and the oil current to the consumers in the lower chassis is determined by the lower-chassis electronic system (10).

64. The method according to claim 30, characterized in thatfordetection of the maximum-load consumer, signals are transmitted via the undercarriage electronics (10) to the superstructure electronics by sensors provided in the load-pressure-carrying lines.

65. The method according to claim 59, wherein the engine is controlled according to an accelerator pedal position and the input and output rotational speed of the transmission (8).

66. The method according to claim 59, wherein steering is optionally performed via joysticks.
